(19) United States
(12) Patent Application Publication
(10) Pub. No.: US 2009/0177398 A1
(43) Pub. Date: Jul. 9, 2009

(54) Angles only navigation system

(75) Inventors: Mikhail Belenkii, San Diego, CA (US); Donald Bruns, San Diego, CA (US); Timothy Brinkley, San Diego, CA (US); George Kaplan, Colora, MD (US)

Correspondence Address: TREX ENTERPRISES CORP., 10455 PACIFIC COURT, SAN DIEGO, CA, 92121, US

(73) Assignee: Trex Enterprises Corp.

(21) Appl. No.: 12/319,651

(22) Filed: Jan. 8, 2009

Related U.S. Application Data
(60) Provisional application No. 61/010,556, filed on Jan. 8, 2008.

(51) Int. Cl. G01C 21/10

(52) U.S. Cl. 701/220

(57) ABSTRACT

An angles only aircraft navigation system. The system includes an IMU coupled with a passive optical sensor. The optical sensor provides periodic updates to the IMU in order to correct for accelerometer and gyro drifts. The IMU computes the air vehicle's instantaneous position, velocity, and attitude using gyro and accelerometer measurements. The optical sensor images stars and satellites. The navigation filter combines optical sensor measurements with IMU inputs, and determines those corrections needed to compensate for the IMU drifts. By applying periodic corrections to the IMU using satellite angular measurements, the navigation filter maintains an accurate position estimate during an entire flight.

### CROSS REFERENCE TO RELATED APPLICATIONS

This application claims the benefit of provisional patent application Ser. No. 61/010,556 filed Jan. 8, 2008.

### FIELD OF INVENTION

The present invention relates to navigation systems and in particular to angles only aircraft navigation systems.

### BACKGROUND OF THE INVENTION

Future aircraft will operate for long durations (from tens of minutes to several hours) at supersonic speeds (Mach 3 to Mach 5) and altitudes of 70,000 feet above ground level. There exists a strong possibility that such vehicles will not be able to rely upon GPS for the entire flight path. In some situations GPS may not be available.

An Inertial Measurement Unit (IMU) can mitigate the effects of GPS denial. However, gyro errors (attitude), accelerometer errors (position and velocity), and the “cross product” of acceleration and attitude errors accumulate over time. Consequently, the IMU precision can drift outside mission required accuracy. A star tracker potentially can provide periodic updates to bound position and attitude errors in the IMU. However, a conventional star tracker on a moving platform has a limitation. It can determine precision attitude fix (pitch, roll and yaw) by imaging two, or more, bright starts separated by a large angular distance. It cannot however determine position fix with respect to terrestrial reference frame. The latter is because a local vertical reference is required to determine position fix from the star measurements. Since neither an accelerometer nor a tilt meter can discriminate between gravity force and acceleration, measurements of the local vertical on a moving platform are very difficult. This places a fundamental limitation on utility of conventional star trackers for High Mach High Altitude (HMHA) air vehicles and Unmanned Air Vehicles (UAV).

At low terrain-following altitudes, a high quality Inertial Navigation System (INS) coupled with a radar altimeter, radar sensor, or Doppler navigation sensor is used by long-range cruise missiles and combat aircrafts. However, at high altitudes, active RF and optical sensors are susceptible to detection by enemy defense systems. This precludes the use of active RF and optical sensors. On the other hand, at high altitudes, optical imaging of the terrain features cannot be used for navigation due to cloud cover over long ranges. This suggests that a non-conventional approach must be developed for GPS denied navigation of high altitude air vehicles.

Inertial navigation systems play a major role in mitigating the effects of GPS denial. The Inertial Measurement Unit (IMU) is initialized at a launcher. Then using a continuous, rapid series of gyro and accelerometer measurements, the IMU computes the air vehicle's instantaneous position, velocity, and attitude at any given later time. However, gyro error (attitude), accelerometer error (position and velocity), and the “cross product” of acceleration and attitude errors accumulate over time. Depending on the precision of the IMU, this “cross product” can accumulate at different rates. To provide accurate position estimates, periodic IMU updates from an external system are required in order to correct for position and attitude drifts, as well as “cross product” of acceleration and attitude error. A passive optical star tracker can potentially provide those periodic updates needed to correct the IMU navigation errors. Celestial-inertial navigation systems have been successfully used on a small number of aircrafts (SR-71, U-2, and B-2 and B-58 bombers).

The concept of Angles-Only, or bearings-only, navigation has been exploited in the areas of naval applications, orbit determination, and target tracking. Angles-Only Navigation determines the position of the air vehicle using angular measurements of satellites whose precise position in 3-D space is accurately known. Therefore this navigation does not require use of the local vertical to determine position. The basic principal of this navigation is simple. By measuring line-of sight angles (i.e. azimuth and elevation angles) from the air vehicle to the satellite, the relative position and velocity between the two objects can be estimated. If the position and velocity of the satellite is known (satellites ephemeris) then the position and velocity of the air vehicle can be determined. In reality, several measurements of different satellites, or one satellite at different times, are required for accurate position determination. Imaging of LEO and GEO satellites has also been experimentally demonstrated under past program at Trex.

Applicant and his fellow workers have developed and field demonstrated an Automated Celestial Navigation System for navigation of surface ships. Under a follow-on contract funded by the National Geospatial Intelligence Agency (NGA), Applicant's employer built an Electronic Replacement for Geodetic Astrolabe for precision mapping of the Earth gravity field. This sensor determined the deflections of vertical of the gravity field with precision of 1 μrad using star measurements. The sensor was also a precision navigator for terrestrial applications with position accuracy of 6 m. In both cases, a precision inclinometer, or tilt meter, was used to measure the local vertical. This measurement was used to convert the observer position in a celestial reference frame, determined from star angular measurements, into a geo-position in a terrestrial reference frame, longitude and latitude. However, on a moving platform, the inclinometer cannot discriminate a gravity field from acceleration, and thus cannot be used to measure local vertical. A novel approach, independent of the local vertical, is required to provide periodic updates for correcting the navigation errors in the IMU.

### SUMMARY OF THE INVENTION

The present invention provides an angles only aircraft navigation system. The system includes an IMU coupled with a passive optical sensor. The optical sensor provides periodic updates to the IMU in order to correct for accelerometer and gyro drifts. The IMU computes the air vehicle's instantaneous position, velocity, and attitude using gyro and accelerometer measurements. The optical sensor images stars and satellites. The navigation filter combines optical sensor measurements with IMU inputs, and determines those corrections needed to compensate for the IMU drifts. By applying periodic corrections to the IMU using satellite angular measurements, the navigation filter maintains an accurate position estimate during an entire flight.

Preferred embodiments include four key components: a) a stabilized mount, or gimbaled platform; b) a star and satellite tracker operating in the short wave infrared spectral waveband (such as 1.6 μm wavelength); c) an IMU co-located with the star/satellite tracker, and d) a Kalman filter that optimally blends the star/satellite tracker data and the IMU measurements together.

### BRIEF DESCRIPTION OF THE DRAWINGS

FIG. 1 shows the geometry of a single observation for an angles only navigation system.

FIG. 2 is a map of GEO, GPS and LEO satellites.

FIG. 3 shows LEO satellites visibility during a great-circle flight just over 2 hours between Washington and London at 3000 km/h at 70,000 ft.

FIG. 4 is a simplified block diagram of conventional Kalman-integrated stabilized stellar-inertial navigator.

FIG. 5 shows a preferred telescopes and mounting structure, looking down the missile axis, in three alternate positions.

FIG. 6 demonstrates that tilting the objective lens of a refracting telescope cancels most of the optical aberrations caused by a cylindrical window.

FIG. 7 is a schematic diagram of a preferred embodiment of the present invention.

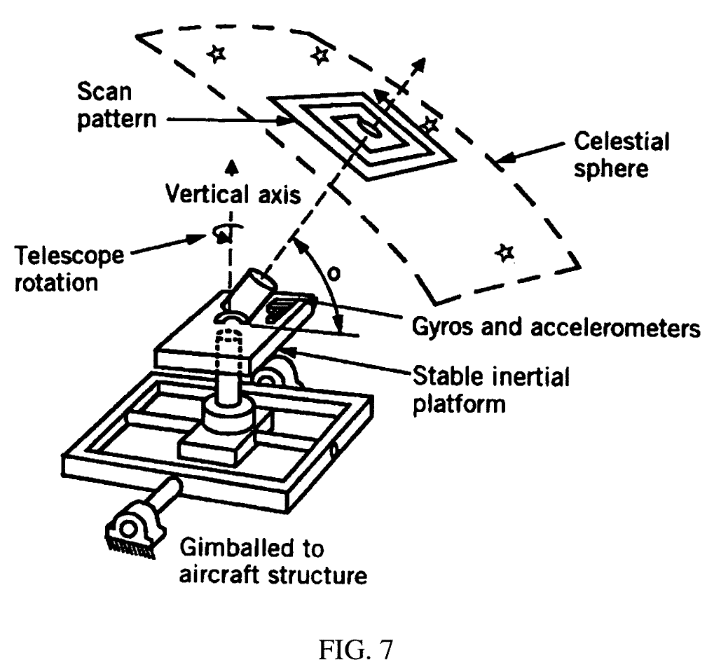

### DETAILED DESCRIPTION OF PREFERRED EMBODIMENTS

To overcome this shortcoming referred to in the background section Applicants have developed a concept of a High Mach, High Altitude (HMHA) Navigator, which determines precision position fix of an air vehicle from line-of-sight measurements to earth orbiting satellites with known positions using an Angles-Only (AO) navigation method. Unlike conventional star trackers, the proposed HMHA navigator does not require a local vertical reference to be known on a moving platform for position and velocity determination. The HMHA navigator enables, for the first time, correction for ALL gyro and accelerometer drifts and errors without local vertical reference, including the “cross-product” of acceleration and gyro errors, using line-of-sight measurements to bright stars and satellites.

The proposed HMHA navigator includes four key components: a) a stabilized mount, or gimbaled platform; b) a star/satellite tracker operating in the short wave infrared (SWIR) spectral waveband (1.6 μm wavelength); c) an IMU co-located with the star/satellite tracker, and d) a Kalman filter that optimally blends the star/satellite tracker data and the IMU measurements together. A star tracker is mounted on a rigid, low-cost, two gimbal stabilized platform. A strap down IMU is mounted at the bottom of this stabilized platform. The star/satellite tracker provides both attitude and position fixes to a navigation Kalman filter. This allows Applicants to bound position and attitude errors in the IMU.

The first technological innovation of the proposed approach is the use of an Angles-Only navigation method for position fix and velocity determination without a local vertical reference and without an input from GPS.

The second innovation is the use of an IMU, which is co-located with a star tracker. This IMU provides vehicle's position and attitude information to the navigation Kalman filter and allows Applicants to accurately point the star tracker at selected stars and satellites. Because two key components, the star tracker and the IMU, are passive and complementary to each other, the HMHA navigator is jam-proof.

The third innovation is an advanced navigation Kalman filter, which integrates both attitude and position fixes from a star/satellite tracker with IMU measurements to bound position and attitude errors. The implication is that the HMHA navigator will provide a complete and robust navigation solution for HMHA air vehicles and UAVs. Using this technology, the HMHA air vehicle can fly for an extended period of time without inputs from GPS, when GPS signals are jammed or unavailable.

Applicants have validated the Angles-Only navigation method in simulation using a Monte-Carlo-like scheme and a Satellite Tool Kit. They have estimated the satellite observation probabilities and predicted observer position accuracy. The simulation confirmed that the AO navigation method is feasible. In addition, they have designed and fabricated a breadboard of a star tracker and observed multiple LEO, GPS, and GEO satellites at sea level in San Diego. A total of 38 LEO satellites and 39 GEO and GPS satellites were observed using a small ground-based telescope. These field measurements validated the feasibility of the proposed approach and provided a basis for defining the design requirements of the HMHA navigator. Lastly, Applicants developed a conceptual design of the HMHA navigator.

### Angles-Only Navigation Method Theory

The concept of Angles-Only (AO) navigation has been exploited in the areas of naval applications, orbit determination, and target tracking. Angles-Only (or bearings-only) navigation involves determining position, velocity and attitude information for an observer using apparent directions or motions of objects at finite distances. As opposed to the stars, earth orbiting satellites are at finite distances. They allow both observer position and velocity determination using only angular measurements of the satellites. The AO method does not require any previous estimate of position or motion, and is of closed form, not stepwise or iterative. It is a least-square-based triangulation generalized to a moving observer, involving only angular observations of objects with known coordinates. It is “absolute” in the sense that it incorporates observations expressed in the same 3-D reference system as the object coordinates. The angular observations are taken at various positions along the observer's track. The observations are assumed to be uncorrelated and to have normally distributed random errors but not significant systematic errors. The solution minimizes the effects of errors in both the observations and in the assumed object coordinates in a least-squares sense. Thus, the Angles-Only approach is based on observations of the directions of identifiable objects with known coordinates, from the point of view of an observer whose own coordinates are to be determined.

For each object observed, two kinds of information are required: the predetermined coordinates of the object, represented by the position vector P; and the observation itself, represented by the direction (unit) vector d. In the absence of errors, the observer must be somewhere on a line of position (LOP) in 3-space given by the equation

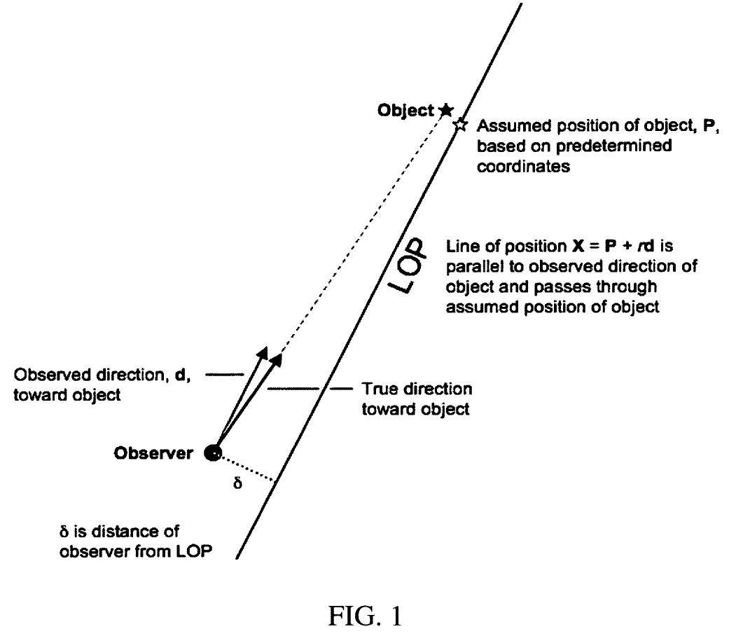

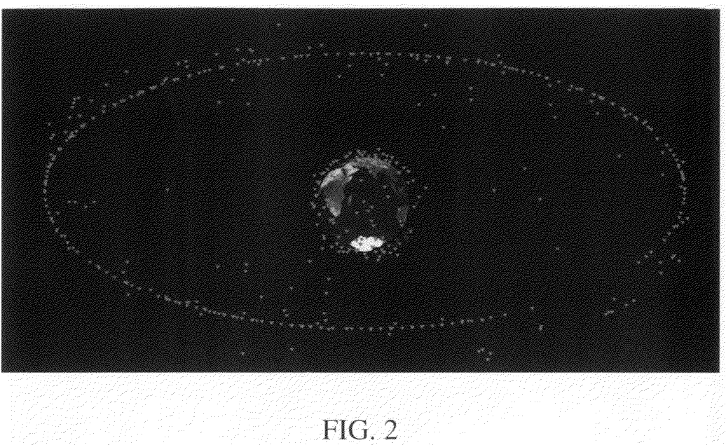

X=P+r d, (1)

where X is the position of an arbitrary point along the line and r is a scalar that can take on any real value. The components of the vectors X and P and the scalar r have units of length, while d is dimensionless. We assume that X, P, and d may be functions of time; for a moving target, the time series of vectors P(t) is referred to as its ephemeris. FIG. 1 shows the geometry of a single observation. Both the observed direction of the object and the object's coordinates are assumed to have some error. Because the AO navigation method is based on line-of-sight measurements to earth orbiting satellites, it is important to know how many satellites are orbiting the Earth and if they are observable. Also Applicants observed earth orbiting satellites using a small ground-based telescope. FIG. 2 depicts a map of Geostationary (GEO), GPS and Low Earth Orbit (LEO) satellites. There are 373 GEO satellites (outer ring at 40,000 km), 33 GPS satellites (intermediate distance, 20,000 km), 155 bright LEO satellites (near Earth's surface, 1000 km-6000 km) and 44 additional LEO navigation satellites (unknown precision). Table 1 presents a list of the 18 LEO satellites whose positions are known at the meter-or-better level.

TABLE 1
(List of the 18 LEO satellites whose ephemeredes are known
at the meter-or-better level)

LAGEOS 1, GRACE 2, GRACE 1, JASON 2, JASON, ENVISAT,
LAGEOS 2, STARLETTE, ICESAT, EGP (AJISAI), EXPLORER 27,
STELLA, TERRA SAR X, ALOS, ERS 2, LARETS, CHAMP, GFO-1

A star tracker can observe GPS and GEO satellites at night. The probability of a direct view of a GPS or GEO satellite is nearly 100%. During the daytime and the terminator, a star tracker can observe sunlit LEO satellites.

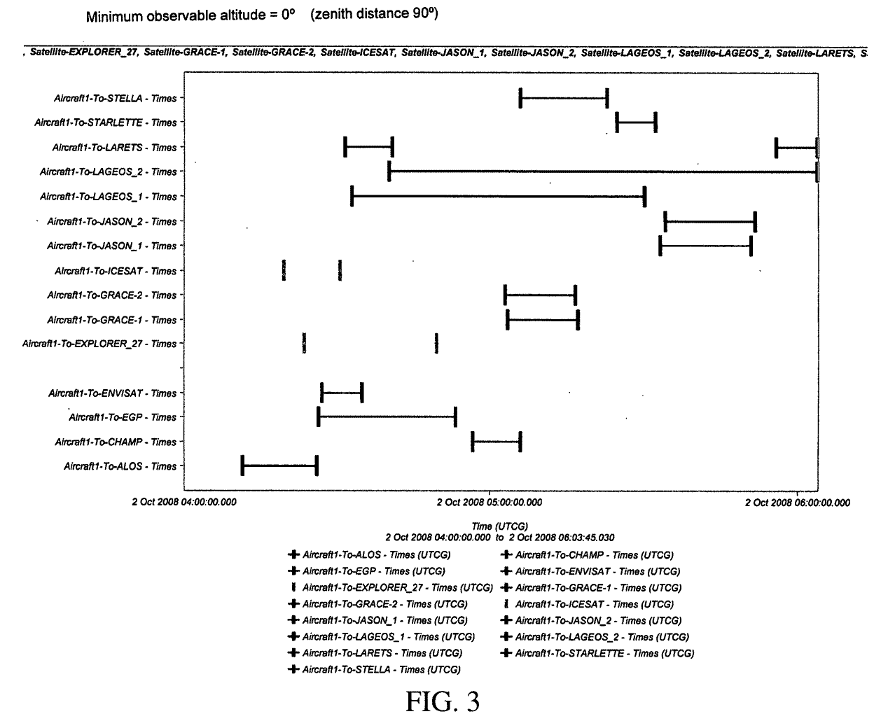

FIG. 3 depicts LEO satellite visibility versus time for a great-circle 2-hour flight calculated using the Satellite Tool Kit. In this example, no satellites were observed for 10% of the flight (at the beginning of the flight), one satellite was observed for 17%, and 2 or more satellites were observed for 72% of the flight. Note that the STK simulation is just one random sample out of all possible flight paths and dates/times.

In collaboration with the United States Naval Observatory (USNO), the performance of the Angles-Only navigation method was evaluated in simulation using a Monte-Carlo-like scheme and the Satellite Tool Kit. The key assumptions are a) satellite-image centroiding uncertainty is 1 arcsec (5 micro radians) and b) satellite ephemeris errors are 3 m. The program assumes that these values represent the standard deviations (1σ) of normal, zero-mean distributions of errors. For each computed observation, a random error from the appropriate distribution is added to each component of the observed satellite's 3-D ephemeris position, and to the true observation angle, in a random direction.

Several categories were simulated: LEO satellites only, GPS satellites only, and two GPS satellites combined with one LEO satellite. For each category, 25 solutions were simulated. The track of the vehicle for all runs was taken to be a great-circle starting at a 60° heading off the U.S. Atlantic coast (latitude +36°, longitude −70°), beginning at various times between 0400 and 0600 UTC on 2 Oct. 2008. The span of observations simulated here for each run was quite short, about 3 minutes, because the vehicle is assumed to be moving very fast (3600 km/h). During that time the vehicle travels almost 200 km.

The simulation revealed that when 3 LEO satellites are observed, the average position error is 17 m. In the case of 2 GPS and one LEO satellites, the average position error is 54 m. Finally, in the case of GPS satellites only, the average position error is 73 m. The above simulation results suggest that Angles-Only navigation method is feasible. However, in order to prove that the corresponding sensor-system can be implemented in hardware suitable for high mach, high altitude air vehicles, Applicants demonstrated that LEO, GPS, and GEO satellites can be observed using a small ground-based telescope. To answer this question, Applicants developed a breadboard and performed a field demonstration in San Diego, Calif.

### Breadboard Design and Fabrication and Field Demonstration

A breadboard star tracker was developed using a 20 cm telescope and a SWIR InGaAs camera available at Trex. Measurements of LEO, GEO, and GPS satellites were performed in San Diego. The telescope was set up at a temporary location about four kilometers northeast of Trex headquarters in San Diego. This location offered unobstructed south and east horizons and convenient day and night operation. The weather offered clear skies and relatively dry conditions. The setup used a fiber optic and an Ethernet cable to transmit data to the desktop computer located indoors about 20 feet away.

TABLE 2
(List of all planned HMHA LEO satellite acquisitions during data collection in San Diego)

| | | | | | | Phase | % | Sun |
|---|---|---|---|---|---|---|---|---|
| Satellite | Date | Result | time | solar deg | range | angle | illuminated | Elevation |
| Starlette | 9/18 | | 19:06:48 | dark | 1083 | 94 | 47 | −4 |
| JASON | 9/18 | bright | 19:24:42 | dark | 1804 | 38 | 90 | −8 |
| EGP | 9/18 | bright | 20:56:32 | dark | 1732 | 71 | 67 | −27 |
| JASON 2 | 9/23 | | 19:20:42 | dark | 1564 | 100 | 42 | −9 |
| LAGEOS | 9/23 | | 19:36:57 | dark | 8382 | 58 | 77 | −12 |
| EGP | 9/23 | bright | 20:31:34 | dark | 1611 | 87 | 53 | −23 |
| TERRA | 10/8 | bright | 17:49:11 | 139 | 1296 | 42 | 88 | 6 |
| LARETS | 10/9 | | 9:48:47 | 72 | 752 | 108 | 34 | 34 |
| ALOS | 10/9 | | 10:48:34 | 33 | 1435 | 147 | 8 | 43 |
| ENVISAT | 10/9 | bright | 11:02:24 | 86 | 1237 | 94 | 46 | 45 |
| STARLETTE | 10/9 | | 11:16:51 | 73 | 1299 | 107 | 36 | 46 |
| EGP | 10/9 | | 14:14:09 | 78 | 2245 | 102 | 40 | 44 |
| STELLA | 10/9 | | 14:53:07 | 39 | 856 | 122 | 24 | 39 |
| EGP | 10/9 | | 16:15:00 | 77 | 1640 | 103 | 39 | 25 |
| ICESAT | 10/13 | | 10:04:01 | 61 | 745 | 120 | 25 | 36 |
| ERS 2 | 10/13 | bright | 11:07:16 | 69 | 1310 | 111 | 33 | 44 |
| ALOS | 10/13 | | 11:51:03 | 76 | 823 | 105 | 37 | 48 |
| JASON | 10/13 | | 13:25:03 | 89 | 2948 | 91 | 49 | 47 |
| JASON 2 | 10/13 | | 13:25:59 | 89 | 2947 | 91 | 49 | 47 |
| EGP | 10/13 | | 14:41:14 | 81 | 1676 | 99 | 42 | 39 |
| TERRA | 10/13 | | 17:58:56 | 145 | 905 | 36 | 91 | 3 |
| EXPLORER 27 | 10/13 | | 18:15:24 | 103 | 1803 | 77 | 61 | 0 |
| LAGEOS 1 | 10/13 | | 20:18:28 | dark | 5971 | 56 | 78 | −26 |
| EXPLORER 27 | 10/13 | | 20:10:26 | dark | 1338 | 68 | 69 | −24 |
| ALOS | 10/14 | | 10:54:34 | 39 | 1277 | 142 | 11 | 42 |
| CHAMP | 10/14 | | 13:57:38 | 99 | 1042 | 81 | 58 | 44 |
| EGP | 10/14 | | 15:50:18 | 104 | 2249 | 75 | 63 | 28 |
| EXPLORER 27 | 10/14 | | 17:32:50 | 113 | 2060 | 67 | 70 | 8 |
| TERRA | 10/14 | | 17:41:45 | 153 | 1265 | 27 | 95 | 6 |
| EXPLORER 27 | 10/14 | dim | 19:27:05 | dark | 1370 | 58 | 77 | −16 |
| EGP | 10/14 | bright | 19:56:19 | dark | 2168 | 57 | 77 | −22 |

A planning list of all the LEO satellite passes, edited to show the data files that were actually saved, is presented in Table 2. The solar angle is the angle between the directions to the sun and to the satellite. The phase angle is the angle between the direction from the satellite to the observer and to the sun (the sum of the solar angle and phase angle is 180°). The range is in kilometers and sun elevation is in degrees. In the cases where the sun is below the horizon, the solar angle is not important; the value was replaced with “dark”. Most of the passes were during the day, when there are many more opportunities to capture images. Over the course of 6 separate days of data collection, a total of 38 LEO satellite passes were recorded, including most of the satellites on the precision-orbit list.

Once the LEO satellite measurements were complete, the imaging system was set up for additional measurements of GPS and GEO satellites. These satellites move much slower than LEO satellites, and hence are easier to track over a limited telescope field of regard. The site used is partially blocked by security walls and a building, but the available field is large enough so that satellites were frequently visible.

Once the data was processed, we were able to identify stars within the FOV and perform radiometry analysis, which will be discussed in detail in the following section. From matched filter star detection, Applicants identified 10 stars within the FOV, the brightest of the identified stars is 1.7 H-band magnitude. These stars acted as calibration references for the radiometry analysis, which yielded in one example an H-band magnitude of −1.3 for the EGP satellite. In another example Applicants measured the satellite brightness to be 5.5 H-band magnitude. Finally, GPS BIIA-11 had (by reference to a star with an H-band magnitude of 4.3) was measured at 8.5 H-band satellite magnitude.

### Radiometry Analysis

Radiometric analysis of the field data was performed by Applicants. Of the 18 LEO satellites whose precise ephemeredes are known at the meter-or-better level, there were 14 potentially observable ones over the course of data collection. The average H-band magnitude was calculated to be 0.6 with a standard deviation of 1.9. A summary of the LEO satellites detected during segments of 6 days of data collection indicates that 4 of the potential 14 LEO satellites were detected at daytime, and 3 of the 14 were detected at night. As far as the limits of detection, we observed H-band magnitude 1 satellites during the daytime and magnitude 3 satellites at night.

For H-band magnitude, 24 of 35 potential GEO satellites were detected at night. The average magnitude is 8.5 with a standard deviation of 0.8. Note that all the GEO satellites were recorded in a single night, with a magnitude of 9.5 being the limit of detection. One Block IIA GPS satellite of magnitude 8.5 was also detected on this same night of data collection.

From the above summarized results, it is clear that many satellites with precision orbits are visible with a 20 cm aperture telescope from sea level. Also, from analysis of the LEO satellite data, the measured sky scatter is less than approximately 100 μW/cm²/ster/μm (H-band) for observation directions more than 70 degrees from the sun. Lastly, for all types of satellites, multiple stars were detected in the field with the satellite in sidereal track. This indicates that precise line-of-sight determination can be made using celestial references.

### Sky Background at 70,000 ft

The sky brightness (radiance plus scatter) has been calculated using MODTRAN3 for fairly benign aerosol models (23 km rural visibility at ground level and sky background stratospheric). The results illustrate that the sky is approximately 100 times dimmer than sea level in the near IR (˜1.5 μm). The dominant noise sources of a SWIR star tracker, sky background and detector noise, are compared in Table 3 below.

TABLE 3
Comparison of the dominant noise sources for SWIR Star Tracker.

| | Sea Level | 70,000 ft |
|---|---|---|
| Sky background (pe/pixel, mean) | 460000 | 4600 |
| Sky background noise (pe/pixel, rms) | 678 | 68 |
| Detector noise (pe/pixel, rms) | 300 | 300 |
| Total noise (pe/pixel, rms) | 742 | 308 |

The results in Table 3 suggest that daytime sky background is negligible at 70,000 ft compared to detector noise.

### Kalman Filter

A navigation Kalman filter combines attitude reference and position fixes from the HMHA with IMU measurements. Since both star measurements (for attitude fix determination) and satellite measurements (for position fix and velocity determination) are performed sequentially and are separated in time, a Kalman filter is required to combine these measurements with the output from the IMU on the moving vehicle. In the Kalman filter, all error states are modeled as zero mean noise processes with known variances, power spectra densities, and time correlation parameters. Thus, the various error quantities and associated measurement noises are all random processes whose correlation structure is assumed to be known. The Kalman filter then obtains estimates of the states of these stochastic processes, which are described by a linearized mathematical model. It is assumed that the correlation structure of the various processes involved and the measurements of linear combination of the error states are known. Both the measurement processes and error propagation in time are expressed in vector form. This provides a convenient way with linear matrix algebra to keep track of relatively complex relationships among all the quantities of interest. Under the assumption of Gaussian noise distribution, the Kalman filter minimizes the mean square error in its estimates of the modeled state variables.

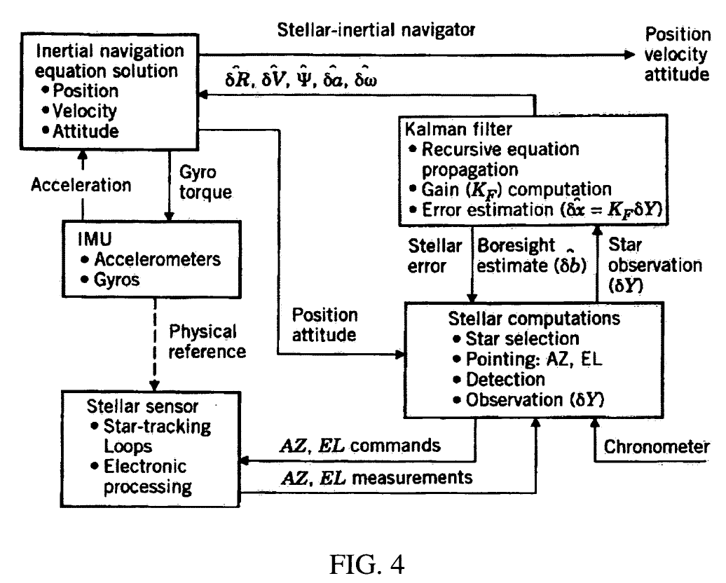

FIG. 4 depicts a simplified block diagram of a stabilized Kalman-integrated stellar-inertial navigator. This navigator provides position, velocity and attitude information by combining IMU measurements with inputs from a stellar sensor. In the case, the stellar sensor exclusively provides the attitude (Az and El) measurements. As opposed to the conventional stellar sensor, the star/satellite tracker in the HMHA provides both attitude and position fixes independent of GPS. To integrate both attitude and position fixes from the star tracker with the IMU measurements to bound position and attitude errors, an advanced navigation Kalman filter is required. Applicants' preferred HMHA embodiment includes an advanced Kalman filter.

### Preferred 21-inch Prototype Design

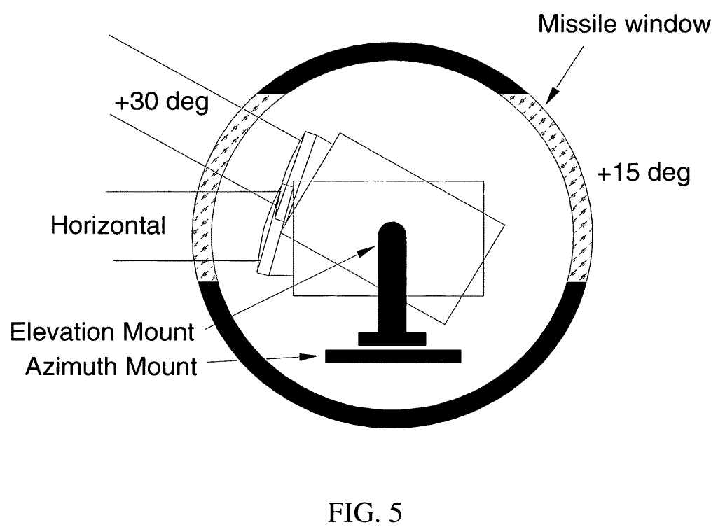

Applicants have developed a preferred 21-inch design for incorporation into a small aircraft. Incorporating a small gimbaled telescope into a 21″ diameter cylindrical housing is a challenge. Applicants assume that the telescope will be somewhere in the center of the missile, surrounded by a cut-away cylindrical window conformal to the outside diameter. This is shown in FIG. 5. The two basic problems are how to design a telescope that can handle the severe wavefront distortions caused by the window, and how to design a gimbal that leaves room for the largest possible telescope aperture.

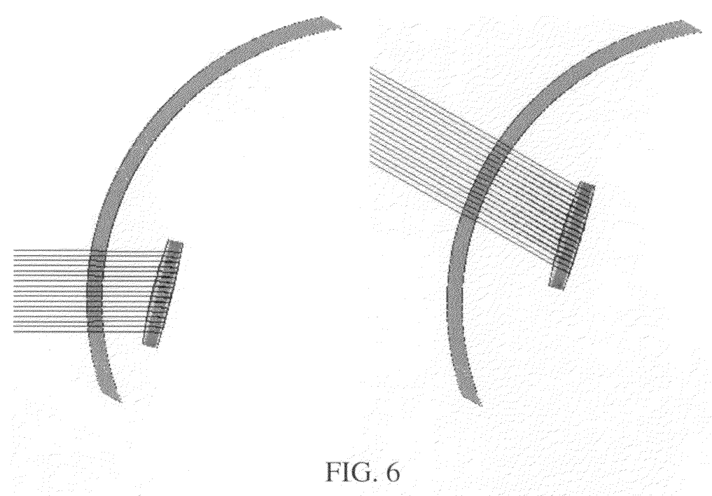

FIG. 5 shows the placement of a 125 mm aperture telescope in the small aircraft. The telescope is approximately 250 mm long, supported by an alt-az gimbal. The telescope is shown in three alternate positions. The telescope can view down to the horizon and up to at least a 45° altitude, where most satellite observations will occur. Note that the optical pupil, a refractor lens in this example, is tilted with respect to the telescope tube, depending on the elevation angle. The refractor lens will be tilted using mechanical actuators. The amount of tilt of the optical pupil will be pre-calculated. To first order, this cancels the optical aberrations caused by the concentric cylindrical window surfaces. Since a diffraction-limited image is not required to image satellites or bright stars, this solution may the most practical. To improve the image further and allow imaging dimmer stars or satellites, some active optical control such as a membrane deformable mirror might be useful. FIG. 6 shows the lens orientation for two cases.

When the telescope scans forward or aft of the centerline, the resulting optical performance is not that different from looking out radially from the missile. If the refractor lens in this example is tilted vertically as shown in FIG. 5, then most of the corrective work is already done. Improving the optical image by adjusting the tilt allows dimmer stars or satellites to be imaged. FIG. 5 also show how the alt-az gimbal fits into the small aircraft. Since observations at angles greater than approximately 45° in either azimuth or elevation are not required, the gimbal is simplified. Only one axis needs to be able to rotate more than 180°.

The smallest telescope that might be used to image bright stars with sufficient resolution has an approximately 30 mm aperture. Thus the requirement that drives the optics design is the need to image dimmer satellites with short exposures. From the preliminary analysis, an aperture between 100 mm and 150 mm is probably sufficient. Preferred embodiments use a reflecting primary and a thick front corrector to form a compact design with a relatively long focal length. The design is easily made more rugged by replacing the aluminum tube structure with more stable carbon composites or titanium rods. The length of the telescope must be kept under approximately 250 mm, but this is easily accomplished by adding small internal fold mirrors near the focal plane.

Preferred gimbles are available form suppliers such as Aerotech and Atlantic Positioning. Cameras may be off the shelf cameras, either visible or short wave infrared cameras.

### Variations

The present invention is very useful for military aircraft which could be operated in regions where GPS is not available or otherwise compromised. Where unit size is not critical, larger telescopes could be utilized to improve performance. Persons skilled in this art will recognize that many other variations are possible within the scope of the present invention; therefore the scope of the present invention should be determined by the appended claims and their legal equivalents rather than by the examples given.

What is claimed is:

1. An angles only navigation system comprising:
A) a stabilized mount;
B) an optical star and satellite tracker;
C) an IMU co-located with the star and satellite tracker, and
D) a Kalman filter adapted to optimally blend the star and satellite tracker data and the IMU measurements together to provide navigation information.

2. The navigation system as in claim 1 wherein the stabilized mount is a gimbled platform.

3. The navigation system as in claim 1 wherein the tracker is adapted to operate in a short wave infrared spectral range.

4. The navigation system as in claim 3 wherein a shortwave infrared spectral range is near 1.5 micron wavelength.

5. The navigation system as in claim 1 wherein the tracker is adapted to operate in a visible spectral range.

6. The navigation system as in claim 1 wherein the angles only navigation is adapted to fit within a high-speed, high-altitude aircraft.

7. The navigation system as in claim 6 wherein the high-speed, high-altitude aircraft is an un-manned arial vehicle.

8. The navigation system as in claim 7 wherein the high-speed, high-altitude aircraft is a guided missile.
